(19) United States
(12) Patent Application Publication
(10) Pub. No.: US 2004/0011895 A1
(43) Pub. Date: Jan. 22, 2004

(54) Fuel injection valve

(76) Inventors: G?uuml;nter Dantes, (US); Detlef Nowak, Untergruppenbach (DE)

Correspondence Address: KENYON & KENYON, ONE BROADWAY, NEW YORK, NY, 10004, US

(21) Appl. No.: 10/297,982

(22) PCT Filed: Apr. 9, 2002
(86) PCT No.: PCT/DE02/01288

(30) Foreign Application Priority Data
Apr. 15, 2001 (DE) 10118276.7

(51) Int. Cl. B05B 1/30

(52) U.S. Cl. 239/585.1

(57) ABSTRACT

The present invention relates to a fuel injector for fuel injection systems of internal combustion engines, including, among others, an actuator (10, 11, 12) and a movable valve part (5, 7) cooperating with a fixed valve-seat (22) that is formed at a valve-seat member (16), to open and close the valve. Positioned downstream from the valve seat (22) is a disk-shaped swirl element (26) which is provided with at least one inlet (27) as well as at least one outlet opening (29), and which includes at least one swirl channel (28) upstream from the outlet opening (29). The swirl element (26) is accommodated in a disk-shaped receiving element (25). Exactly one supply duct (33) formed in the receiving element (25) is directed to each inlet end (34) of a swirl channel (28).

The fuel injector is particularly suitable as a high-pressure injector for direct fuel injection into a combustion chamber of a mixture-compressing internal combustion engine using external ignition.

### BACKGROUND INFORMATION

The present invention is based on a fuel injector according to the species defined in claim 1.

It is already widely known to provide fuel injectors with swirl-generating elements, which impart a swirl component to the fuel to be sprayed off, so that the fuel is better atomized and disintegrates into smaller droplets. In this context, it is already known, on the one hand, to locate the swirl-generating means upstream, i.e. upstream from the valve seat, and, on the other hand, downstream, i.e. behind the valve seat.

Swirl-generating means located downstream from the valve seat are usually configured in such a way as to supply fuel to radially outward-lying ends of swirl channels, the fuel then being radially guided inward to a swirl chamber, which it enters with a tangential component. The swirl-imparted fuel then emerges from the swirl chamber. From the laid-open document DE-OS 198 15 775, a fuel injector is already known in which a swirl plate having such a flow is provided downstream from the valve seat. The fuel is conveyed to inlet regions of the swirl channels of the swirl plate without directed flow; there is no directed flow toward the swirl channels.

So-called multi-layer electroplating for producing orifice plates that are particularly suitable for use in fuel injectors has already been described in detail in the laid-open document DE OS 196 07 288. This manufacturing principle for producing disks using multiple electroplating metal deposition of different patterns on one another, so that a one-piece disk results, expressly is to be part of the disclosure of the present invention. Micro-electroplating metal deposition in several surfaces or layers may likewise be used to produce the swirl plates.

### SUMMARY OF THE INVENTION

The fuel injector according to the present invention having the characterizing features of claim 1 has the advantage over the related art that a very high atomization quality of a fuel to be spray-discharged is obtained. As a result, such an injector of an internal combustion engine makes it possible, among other things, to reduce the exhaust-gas emission of the internal combustion engine and also to lower the fuel consumption.

In an advantageous manner, the fuel flow through the swirl channels is very precise and reliable. In a receiving element, supply ducts oriented toward the inlet ends of the swirl channels are provided, whose number corresponds exactly to the number of swirl channels in the swirl element following downstream, so that the fuel supply of the swirl channels is implemented in the direction of the flow. Such an arrangement makes it possible to reduce the dead volume in the incident flow behind the valve seat. The danger of so-called late sprays during engine operation is sharply reduced in this manner, since only a small quantity of fuel, or no fuel at all, is stored in the inflow region.

Advantageous further refinements and improvements of the fuel injector mentioned in claim 1 are rendered possible by the measures specified in the dependent claims.

A transverse spray-off of fuel at an angle γ with respect to the longitudinal valve axis, as might be required under certain installation conditions, may be accomplished very easily by using the fuel injector of the present invention. In such a case, the swirl element is installed at an incline, as a result of which the supply ducts in the receiving element may have different lengths.

The swirl element may be manufactured inexpensively in an especially advantageous manner. A particular advantage is that the swirl disks may be produced simultaneously and extremely precisely in large quantities in a reproducible manner (high batch capability). It is particularly advantageous in this context to produce the swirl disk using so-called multilayer electroplating. Due to their metal design, such swirl elements are very safe from breakage and are easy to install. Using multilayer electroplating grants an extremely high design freedom since the contours of the opening regions (swirl channels, outlet opening) in the swirl disk may be freely selected.

### BRIEF DESCRIPTION OF THE DRAWING

An exemplary embodiment of the present invention is represented in the drawing in simplified form and elucidated in more detail in the following description. The Figures show:

FIG. 1 a partially represented fuel injector in a section; and

FIG. 2 a top view of the swirl element installed in the fuel injector according to FIG. 1.

### DESCRIPTION OF THE EXEMPLARY EMBODIMENTS

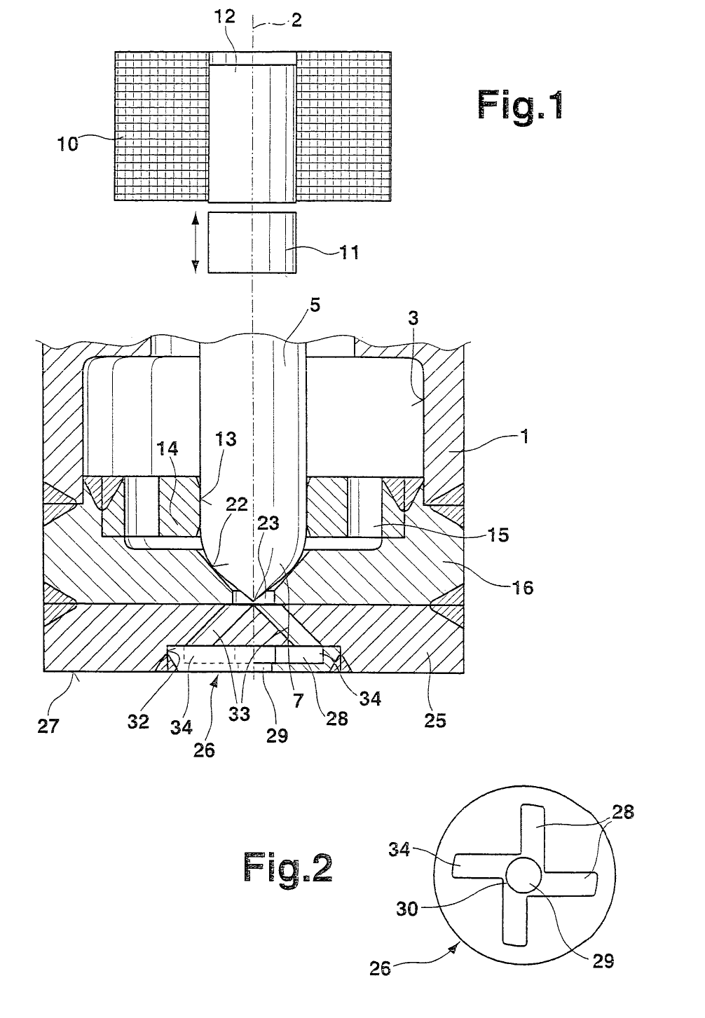

FIG. 1 partially shows in simplified form a valve in the form of an injection valve for fuel injection systems of mixture-compressing, externally ignited internal combustion engines as an exemplary embodiment. The injection valve has a tubular valve-seat support 1, in which a longitudinal opening 3 is formed concentrically to a valve longitudinal axis 2. Disposed in longitudinal opening 3 is a valve needle 5, which has a valve-closure section 7 at its downstream end.

The fuel injector is actuated in a known manner, e.g. electromagnetically. For axial movement of valve needle 5, and thus for opening a restoring spring (not shown) against the spring tension, or for closing the fuel injector, a schematically sketched electromagnetic circuit including a magnetic coil 10, an armature 11 and a core 12 is used. Armature 11 is connected to the end of valve needle 5 facing away from valve-closure section 7 by a welding seam formed by laser, for instance, and points to core 12.

Instead of the electromagnetic circuit, another energizable actuator, e.g. a piezo stack, may also be used in a comparable fuel injector, or the axially movable valve part may be actuated by hydraulic pressure or servo pressure.

During the axial movement, valve needle 5 is guided by a guide opening 13 of a guide element 14. Guide element 14 is provided with at least one flow opening 15 through which fuel may flow from longitudinal opening 3 in the direction of a valve seat. Guide element 14, which may be in the shape of a disk, for instance, is fixedly connected to a valve-seat member 16 by a circumferential welding seam, for example. Valve-seat member 16 is sealingly mounted by welding, for example, on the end of valve-seat support 1 facing away from core 12.

The position of valve-seat member 16 determines the magnitude of the lift of valve needle 5 since the one end position of valve needle 5 in the case of a non-energized magnetic coil 10 is specified by the seating of valve-closure section 7 at a valve-seat surface 22 of valve-seat member 16, this valve-seat surface 22 tapering conically in a downstream direction. Given an energized magnetic coil 10, the other end position of valve needle 5 is specified, e.g. by the seating of armature 11 on core 12. Therefore, the path between these two end positions of valve needle 5 represents the lift. Valve-closure section 7 cooperates with truncated-cone-shaped valve-seat surface 22 of valve-seat member 16 to form a sealing seat. Downstream from valve-seat surface 22, valve-seat member 16 has a central outlet opening 23.

Mounted on valve-seat member 16, downstream from outlet opening 23, is a receiving element 25, which may be disk-shaped, for instance, and which securely supports a smaller, also disk-shaped swirl element 26 and selectively conveys fuel to this swirl element 26. Receiving element 25 is likewise mounted on valve-seat member 16 by welding, for instance.

Receiving element 25 has a depression 32 at its downstream end face 27 to accommodate swirl element 26, the axial depth of depression 32 corresponding at least approximately to the thickness of swirl element 26, so that swirl element 26 ends flush with, for example, end face 27 of receiving element 25. Receiving element 25 has bore-type supply ducts 33 that are oriented toward the outer inlet ends 34 of swirl channels 28, whose number corresponds exactly to the number of radially inward-extending swirl channels 28 of swirl element 26. All supply ducts 33 of receiving element 25 are directly supplied with fuel emerging from outlet opening 23. Beginning with this central region of supply ducts 33, supply ducts 33 extend at an incline with an axial and an outward-oriented radial component. In this manner, the fuel is supplied to swirl channels 28 in the direction of the flow. Such an arrangement makes it possible to reduce the dead volume in the incident flow downstream from the valve seat. Supply ducts 33 are introduced into receiving element 25 by drilling, eroding or laser drilling, for example.

Swirl element 26 is a disk-shaped component which is configured as a spray-orifice plate and has two layers, for instance. Across both layers, swirl element 26 has a circumferential edge enclosing an inner opening structure which, in the upper position facing valve-seat member 16, surrounds swirl channels 28 including their inlet ends 34 and an inner swirl chamber 30, while, in the lower position, the opening structure is formed by an outlet opening 29 following swirl chamber 30.

FIG. 2 shows a top view of swirl element 26 inserted into the fuel injector according to FIG. 1. Swirl element 26 is provided with four swirl channels 28, for example, whose inlet ends 34 are supplied with fuel from four supply ducts 33, exactly one supply duct ending at a swirl channel 28. Swirl channels 28 extend from inlet ends 34 radially toward the inside, to discharge tangentially into swirl chamber 30 situated in the region of valve-longitudinal axis 2. From there, the swirl-imparted fuel leaves swirl element 26 via outlet opening 29.

A transverse spray-off of fuel at an angle γ with respect to the longitudinal valve axis, as might be required under certain installation conditions, may also be accomplished very easily when using the fuel injector of the present invention. In such a case, swirl element 26 is mounted in receiving element 25 at an incline, which is why supply ducts 33 in receiving element 25 then have differing lengths, depending on the distance of inlet ends 34 of swirl channels 28 from outlet opening 23.

Swirl disk 26 is built up in a plurality of metallic layers, e.g. by electrodeposition (multi-layer electroplating). Due to the deep-lithographic production using electroplating technology, particular features are found in the shaping, some of which are briefly indicated here: —layers having a constant thickness over the disk surface;—substantially vertical cuts in the layers that form the hollow spaces flowed through in each case as a result of the deep-lithographic structuring (deviations of about 3° with respect to optimally vertical walls may occur as a function of production engineering);

desired undercuts and overlappings of the cuts due to multi-layer design of individually patterned metal layers;

cuts having any cross-sectional forms having largely axially parallel walls;

one-piece design of the swirl element since the individual metal deposits occur in immediate succession.

However, the incident flow of swirl channels 28 of swirl element 26 according to the present invention is entirely independent of the manufacturing method of swirl element 26. It may also be formed using other conventional manufacturing methods, from metal, plastic or other materials.

What is claimed is:

1. A fuel injector for fuel injection systems of internal combustion engines, especially for the direct injection of fuel into a combustion chamber of an internal combustion engine, having a valve longitudinal axis (2), having an actuator (10, 11, 12), having a movable valve component (5, 7) which cooperates with a fixed valve seat (22) formed at a valve-seat member (16) to open and close the valve, and having a swirl element (26) located downstream of the valve seat (22), which is provided with at least one inlet as well as at least one outlet opening (29), and which has at least one swirl channel (28) upstream from the outlet opening (29);
wherein the swirl element (26) is accommodated in a receiving element (25), and exactly one supply duct (33) formed in the receiving element (25) is directed to each inlet end (34) of a swirl channel (28).

2. The fuel injector as recited in claim 1,
wherein, downstream from the valve seat (22), an outlet opening (23) is centrally provided in the valve-seat member (16), which directly supplies all supply ducts (33) in the receiving element (25).

3. The fuel injector as recited in claim 1 or 2,
wherein the receiving element (25) and the swirl element (26) are each implemented in disk-form.

4. The fuel injector as recited in claim 3,
wherein the receiving element (25) has a depression (32) at its downstream face end (27) in which the swirl element (26) is mounted.

5. The fuel injector as recited in one of claims 1 through 4,
wherein the supply ducts (33) are implemented as bores in the receiving element (25).

6. The fuel injector as recited in one of the preceding claims,
wherein the supply ducts (33) extend at an incline to an axial component and an outwardly directed radial component.

7. The fuel injector as recited in claim 5 or 6,
wherein the supply ducts (33) are able to be formed by drilling, eroding or laser drilling.

8. The fuel injector as recited in one of the preceding claims,
wherein the swirl channels (28) extend from the inlet ends (34) radially inwards to a swirl chamber (30).

9. The fuel injector as recited in one of claims 1 through 8,
wherein the swirl element (26) may be produced by multi-layer galvanic metal deposition.

10. The fuel injector as recited in one of the preceding claims,
wherein the receiving element (25) is fastened to the valve-seat member (16).
Please add the following claims:

11. (New) A fuel injecton system of an internal combustion engine, having a valve longitudinal axis, the fuel injector comprising:
an actuator;
a valve-seat member;
a fixed valve seat situated at the valve-seat memeber;
a moveable valve component cooperating with the fixed valve seat to open and close the valve;
a swirl element situated downstream of the valve seat;
at least one inlet and at least one outlet opening;
at least one swirl channel situated upstream from the outlet opening, the swirl channel having inlet ends;
a receiving element for accommodating the swirl element; and
supply ducts situated in the receiving element, exactly one of the supply ducts being directed to each of the inlet ends of the swirl channel.

12. (New) The fuel injector according to claim 11, wherein the fuel injector is for a direct injection of fuel into a combustion chamber of the internal combustion engine.

13. (New) The fuel injector according to claim 11, further comprising a further outlet opening situated downstream from the valve seat and situated centrally in the valve-seat member, directly supplying all of the supply ducts in the receiving element.

14. (New) The fuel injector according to claim 11, wherein the receiving element and a the swirl element are in a disk-form.

15. (New) The injector according to claim 14, wherein the receiving element has a depression at a downstream face end in which the swirl element is mounted.

16. (New) The fuel injector according to claim 11, wherein the supply ducts are bores in the receiving element.

17. (New) The fuel injector according to claim 11, wherein the supply ducts extends at an incline to an axial component and an outwardly directed radial component.

18. (New) The fuel injector according to claim 11, wheren the supply ducts are formed by one of drilling, enroding and laser drilling.

19. (New) The fuel injector according to claim 11, further comprising a swirl chamber, the at least one swirl channel extending from the inlet ends radially inmards to the swirl chamber.

20. (New) The fuel injector according to claim 11, wherein the swirl element is produced by multi-layer galvanic metal deposition.

21. (New) The fuel injector according to claim 11, wherein the receiving element is fastened to the valve-seat memeber.
